(19) United States
(12) Patent Application Publication
(10) Pub. No.: US 2010/0018356 A1
(43) Pub. Date: Jan. 28, 2010

(54) Ratchet Wrench with Three Operative Positions

(76) Inventor: Bobby Hu, Taichung (TW)

Correspondence Address: KAMRATH & ASSOCIATES P.A., 4825 OLSON MEMORIAL HIGHWAY, SUITE 245, GOLDEN VALLEY, MN, 55422, US

(21) Appl. No.: 12/273,627

(22) Filed: Nov. 19, 2008

(30) Foreign Application Priority Data
Jul. 25, 2008 (TW) 097128446

(51) Int. Cl. B25B 13/46

(52) U.S. Cl. 81/63.1

(57) ABSTRACT

A ratchet wrench includes a body with a driving portion having first, second, and third compartments in communication with each other. A drive member is rotatably received in the first compartment. The driving portion includes first and second sides spaced in a thickness direction. The third compartment extends from the first side toward and spaced from the second side. The third compartment includes a bottom wall intermediate the first side and a center of the second compartment in the thickness direction. Two pawls are received in the second compartment and releasably engaged with teeth of the drive member. A control member is pivotably received in the third compartment and operable to selectively press against one of the pawls to change the driving direction of the ratchet wrench.

### BACKGROUND OF THE INVENTION

1. Field of the Invention

The present invention relates to a ratchet wrench and, more particularly, to a ratchet wrench that includes three operative positions and that has a high torque-bearing capacity.

2. The Prior Arts

Taiwan Patent Publication No. 399509 entitled “IMPROVED DIRECTION SWITCHING STRUCTURE FOR RATCHET WRENCH” discloses a ratchet wrench including a body having a head. The head includes a compartment in which a gear wheel is rotatably mounted. A transverse hole extends from a lateral side of the head through the other lateral side of the head and is in communication with the compartment. Two pawls are slideably received in two ends of the transverse hole and releasably meshed with the gear wheel. A switch hole is defined in a top side of the head for pivotably receiving a switch. The switch includes an actuating portion selectively pressing against one of the pawls to change the driving direction of the ratchet wrench by pivotal movement of the switch between two positions. However, the depth of the switch hole is about ¾ of the depth of the body. Namely, the structural strength of the head is significantly weakened by the switch hole. When driving a fastener with the ratchet wrench, an inner end of one of the pawls engaged with the gear wheel is not supported. Specifically, the inner end of the pawl engaged with the gear wheel is not in rigid contact with the body, such that the torque imparted to the pawl engaged with the gear can not be transmitted to the body through the entire length of the pawl. The torque-bearing capacity of the pawl is, thus, low and does not meet the needs of professional users.

Thus, a need exists for a ratchet wrench with a high torque-bearing capacity.

### SUMMARY OF THE INVENTION

The present invention solves this need and other problems in the field of high torque-bearing capacity wrenches by providing, in a preferred form, a ratchet wrench including a body having a driving portion and a handle interconnected to the driving portion. The driving portion includes first and second sides spaced in a thickness direction. The driving portion includes a first compartment and a second compartment formed between the first and second sides and in communication with the first compartment. The second compartment includes at least one opening in communication with an outside. A third compartment extends from the first side toward and spaced from the second side and in communication with the second compartment. The third compartment includes a bottom wall intermediate the first side and a center of the second compartment in the thickness direction. At least one plug is mounted in the at least one opening to seal the at least one opening. A drive member is rotatably received in the first compartment and includes a plurality of teeth in an outer periphery thereof. First and second pawls are slideably received in the second compartment. Each of the first and second pawls includes inner and outer ends and an inner face interconnected between the inner and outer ends and facing the teeth of the drive member. The inner face of each of the first and second pawls includes a plurality of teeth releasably engaged with the teeth of the drive member. A first elastic element is mounted in the second compartment and biases the outer end of the first pawl to engage the teeth of the first pawl with the teeth of the drive member. A second elastic element is mounted in the second compartment and biases the outer end of the second pawl to engage the teeth of the second pawl with the teeth of the drive member. A control member is pivotably mounted in the third compartment about a pivot axis. The control member includes a control section in the most preferred form as a rib selectively pressing against the inner end of one of the first and second pawls to disengage the teeth of the one of the first and second pawls with the teeth of the drive member.

In the most preferred form, the control member includes first and second faces spaced in the thickness direction, and the rib is formed on the second face. Furthermore, the second face of the control member includes first, second, and third positioning holes corresponding to first, second, and third operative positions of the control member. A positioning member and a third elastic element are received in the receiving hole. The third elastic element biases the positioning member into one of the first, second, and third positioning holes to retain the control member in one of the first, second, and third operative positions.

When the control member is in the first operative position, the rib presses against the inner end of the first pawl to disengage the teeth of the first pawl from the teeth of the drive member, and the teeth of the second pawl are engaged with the teeth of the drive member, allowing the drive member to rotate in a first direction driving a fastener in the first direction, and allowing the drive member to rotate freely in a second direction reverse to the first direction without driving the fastener.

When the control member is in the third operative position, the rib presses against the inner end of the second pawl to disengage the teeth of the second pawl from the teeth of the drive member, and the teeth of the first pawl are engaged with the teeth of the drive member, allowing the drive member to rotate in the second direction driving the fastener in the second direction, and allowing the drive member to rotate freely in the first direction without driving the fastener.

When the control member is in the second operative position, the rib is intermediate and spaced from the inner ends of the first and second pawls. The teeth of each of the first and second pawls are engaged with the teeth of the drive member, allowing the drive member to rotate in either of the first and second directions driving the fastener, and not allowing free rotation of the drive member in either of the first and second directions without driving the fastener.

The present invention will become clearer in light of the following detailed description of illustrative embodiments of this invention described in connection with the drawings.

### BRIEF DESCRIPTION OF THE DRAWINGS

The illustrative embodiments may best be described by reference to the accompanying drawings where:

FIG. 1 shows a perspective view of a ratchet wrench according to the preferred teachings of the present invention.

FIG. 2 shows an exploded, perspective view of the ratchet wrench of FIG. 1.

FIG. 3 shows a bottom, perspective view of a control member of the ratchet wrench of FIG. 1.

FIG. 4 shows a partial, cross sectional view of the ratchet wrench of FIG. 1 according to section line 4-4 of FIG. 1.

FIG. 4A shows an enlarged view of a circled portion in FIG. 4.

FIG. 5 shows a partial, cross sectional view of the ratchet wrench of FIG. 1 according to section line 5-5 of FIG. 4 with the control member in a second operative position.

FIG. 6 shows a partial, cross sectional view similar to FIG. 5 with the control member in a third operative position.

FIG. 7 shows a partial, cross sectional view similar to FIG. 5 with the control member in a first operative position.

FIG. 8 shows a partial, cross sectional view of a ratchet wrench of a second embodiment according to the preferred teachings of the present invention.

FIG. 9 shows a partial, cross sectional view of a ratchet wrench of a third embodiment according to the preferred teachings of the present invention.

FIG. 10 shows a partial, cross sectional view of a ratchet wrench of a fourth embodiment according to the preferred teachings of the present invention.

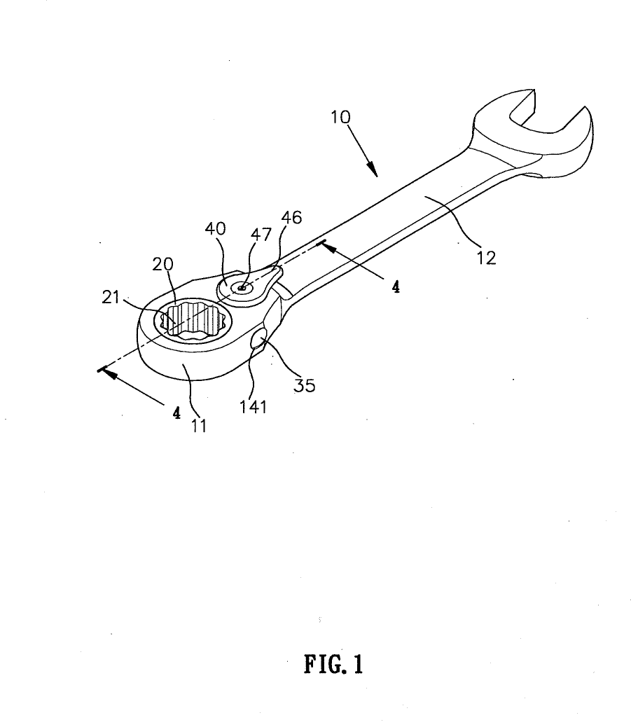

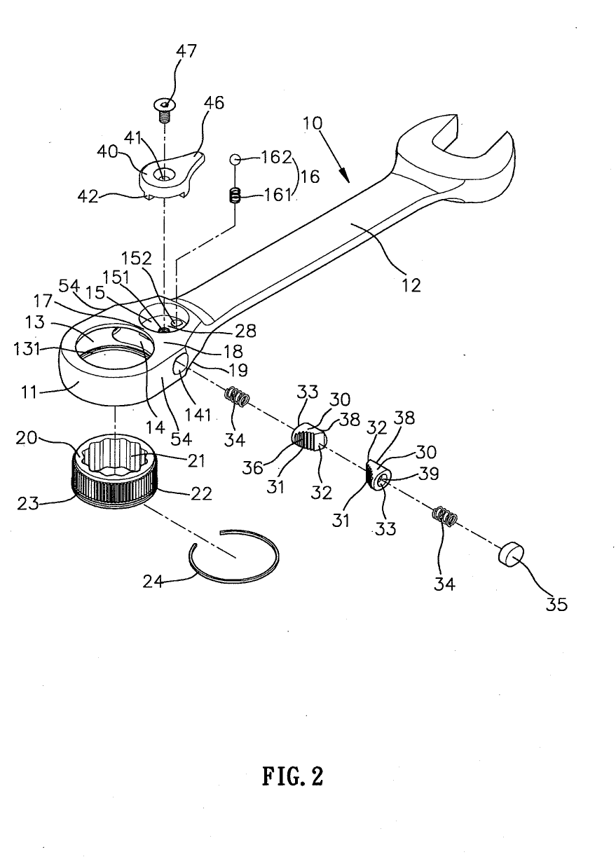

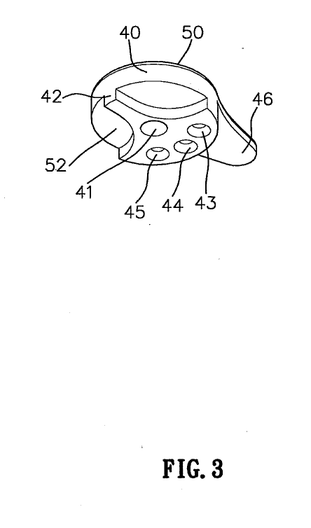

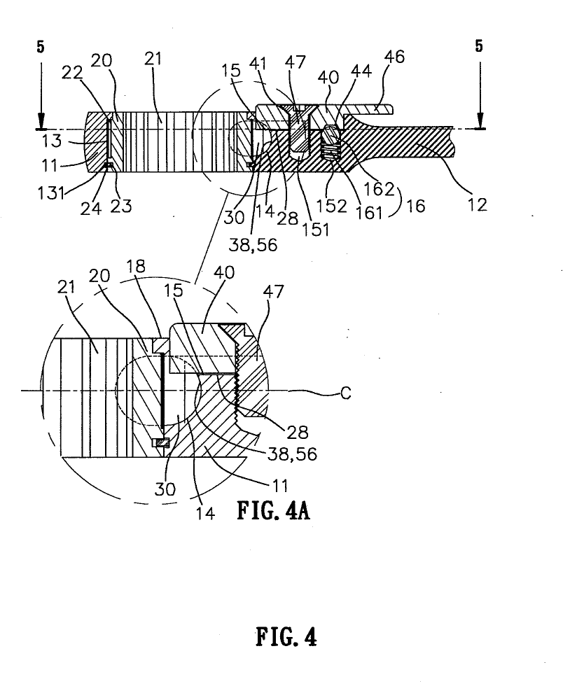

All figures are drawn for ease of explanation of the basic teachings of the present invention only; the extensions of the figures with respect to number, position, relationship, and dimensions of the parts to form the preferred embodiment will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

Where used in the various figures of the drawings, the same numerals designate the same or similar parts. Furthermore, when the terms “first”, “second”, “third”, “fourth”, “inner”, “outer”, “side”, “end”, “portion”, “section”, “annular”, “lateral”, “peripheral”, “clockwise”, “counterclockwise”, “length”, “width”, “thickness”, and similar terms are used herein, it should be understood that these terms have reference only to the structure shown in the drawings as it would appear to a person viewing the drawings and are utilized only to facilitate describing the invention.

### DETAILED DESCRIPTION OF THE PREFERRED EMBODIMENTS

A ratchet wrench according to the preferred teachings of the present invention is shown in the drawings and generally includes a body 10 having a driving portion 11 and a handle 12 interconnected to driving portion 11. Driving portion 11 includes first and second sides 18 and 19 spaced in a thickness direction and first and second lateral sides 54 spaced in a width direction perpendicular to the thickness direction. Driving portion 11 further includes a first compartment 13 in the most preferred form shown as a through-hole extending from first side 18 through second side 19 in the thickness direction. An annular groove 131 is defined in an end of a peripheral wall of first compartment 13. Driving portion 11 further includes a second compartment 14 formed between first and second sides 18 and 19 and in communication with first compartment 13. A third compartment 15 extends from first side 18 toward and spaced from second side 19. Third compartment 15 includes a bottom wall 28 intermediate first side 18 and a center of second compartment 14 in the thickness direction. Bottom wall 28 includes a fixing hole 151 in the most preferred form shown as a screw hole and a receiving hole 152 in the most preferred form shown as a blind hole. Second compartment 14 is intermediate first and third compartments 13 and 15 in a length direction perpendicular to the thickness and width directions. Furthermore, third compartment 15 is spaced from first compartment 13 by a bridge 17 that is a part of first side 18. Further, bridge 17 forms a sidewall delimiting second compartment 14. According to the most preferred form shown, second compartment 14 further includes an opening 141 formed in first lateral side 54 and in communication with an outside. Second compartment 14 further includes a closed end wall 144 opposite to opening 141. End wall 144 has a receptacle 142 facing opening 141. A plug 35 is mounted in opening 141 to seal opening 141. Plug 35 includes a receptacle 351.

According to the preferred form shown, a drive member 20 is rotatably received in first compartment 13. Drive member 20 includes a driving section 21 in a central portion thereof for directly or indirectly engaging with a fastener to be loosened or tightened. According to the most preferred form shown, driving section 21 includes a through-hole having a polygonal inner periphery for directly engaging with and driving a fastener. Other forms of driving section 21 would be within the skill of the art. Drive member 20 further includes a plurality of teeth 22 in an outer periphery thereof. An annular groove 23 is formed in an end of the outer periphery of drive member 20. A retainer ring 24 in the most preferred form shown as a C-clip is partially received in annular groove 23 of drive member 20 and partially received in annular groove 131 of body 10, allowing rotation of drive member 20 relative to body 10 while retaining drive member 20 in first compartment 13.

According to the preferred form shown, first and second pawls 30 are slideably received in two ends of second compartment 14. Each of first and second pawls 30 includes inner and outer ends 32 and 33 and an inner face 36 interconnected between inner and outer ends 32 and 33 and facing teeth 22 of drive member 20. Inner face 36 of each of first and second pawls 30 includes a plurality of teeth 31 releasably engaged with teeth 22 of drive member 20. Outer end 33 of each of first and second pawls 30 includes a receptacle 39. Each of first and second pawls 30 further includes an outer face 38 interconnected between inner and outer ends 32 and 33 and opposite to inner face 36. An elastic element 34 in the most preferred form shown as a spring is mounted in second compartment 14 and has two ends received in receptacle 351 of plug 35 and receptacle 39 of first pawl 30 to bias teeth 31 of first pawl 30 to engage with teeth 22 of drive member 20. Another elastic element 34 in the most preferred form shown as a spring is mounted in second compartment 14 and has two ends received in receptacle 142 of end wall 144 and receptacle 39 of second pawl 30 to bias teeth 31 of second pawl 30 to engage with teeth 22 of drive member 20.

According to the preferred form shown, a control member 40 is pivotably mounted in third compartment 15 and seals second and third compartments 14 and 15 after assembly. Control member 40 includes first and second faces 50 and 52 spaced in the thickness direction. A control section 42 in the most preferred form shown as a rib formed on second face 52. Control member 40 further includes a through-hole 41 extending from first face 50 through second face 52. A pivot 47 in the most preferred form shown as a screw is extended through through-hole 41 of control member 40 and engaged in fixing hole 151. Thus, control member 40 is pivotable relative to body 10 about a pivot axis defined by pivot 47. Second face 52 of control member 40 further includes first, second, and third positioning holes 43, 44, and 45 corresponding to first, second, and third operative positions of control member 40. A positioning device 16 is provided to position control member 40 in one of the first, second, and third operative positions. Positioning device 16 is received in receiving hole 152 and includes a positioning member 162 in the most preferred form shown as a ball and an elastic element 161 in the most preferred form shown as a spring. Elastic element 161 biases positioning member 162 into one of first, second, and third positioning holes 43, 44, and 45 to retain control member 40 in one of the first, second, and third operative positions. Other forms of positioning device 16 would be within the skill of the art. According to the most preferred form shown, control member 40 further includes a manually operable thumb piece 46 to allow easy pivotal movement.

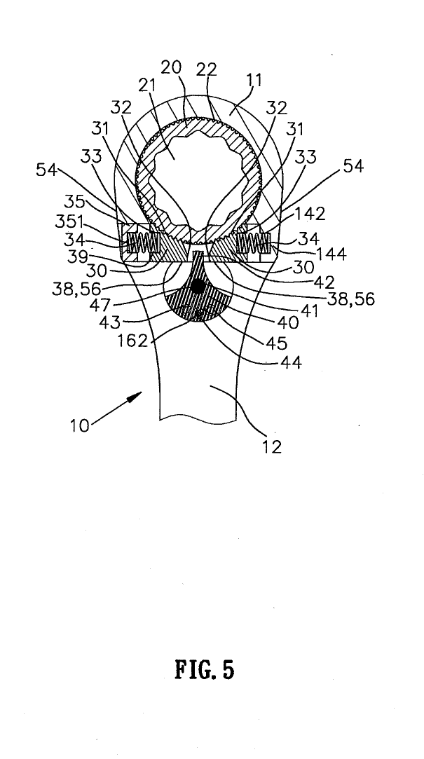

Now that the basic construction of the ratchet wrench of the preferred teachings of the present invention has been explained, the operation and some of the advantages of the ratchet wrench can be set forth and appreciated. In particular, for the sake of explanation, it will be assumed that control member 40 is initially in the second operative position (FIG. 5) intermediate the first and third operative positions. Positioning member 162 is received in second positioning hole 44 of control member 40. Control section 42 of control member 40 is intermediate and spaced from inner ends 32 of first and second pawls 30. Furthermore, teeth 31 of each of first and second pawls 30 are engaged with teeth 22 of drive member 20, allowing the drive member 20 to rotate in either of clockwise and counterclockwise directions to drive a fastener in the same direction. Free rotation of drive member 20 in a reverse direction without driving the fastener is not allowed. Namely, rotation of drive member 20 in a reverse direction drives the fastener in the reverse direction. Further, the ratchet wrench according to the preferred teachings of the present invention can be utilized to perform slight tightness adjustment of the fastener when control member 40 is in the second operative position. When rotating the ratchet wrench in the counterclockwise direction, a portion of outer face 38 of first pawl 30 adjacent inner end 32 of first pawl 30 presses against a peripheral wall 56 delimiting second compartment 14 by a large area compared to that in conventional wrenches. This is because bottom wall 28 of third compartment 15 is intermediate first side 18 and the center of second compartment 14 in the thickness direction. Thus, the torque imparted to first pawl 30 can be transmitted to body 10. Likewise, when rotating the ratchet wrench in the clockwise direction, a portion of outer face 38 of second pawl 30 adjacent inner end 32 of second pawl 30 presses against a peripheral wall 56 delimiting second compartment 14 by a large area compared to that in conventional wrenches, so that the torque imparted to first pawl 30 can be transmitted to body 10. Accordingly, the ratchet wrench according to the preferred teachings of the present invention can withstand higher torque than conventional ones.

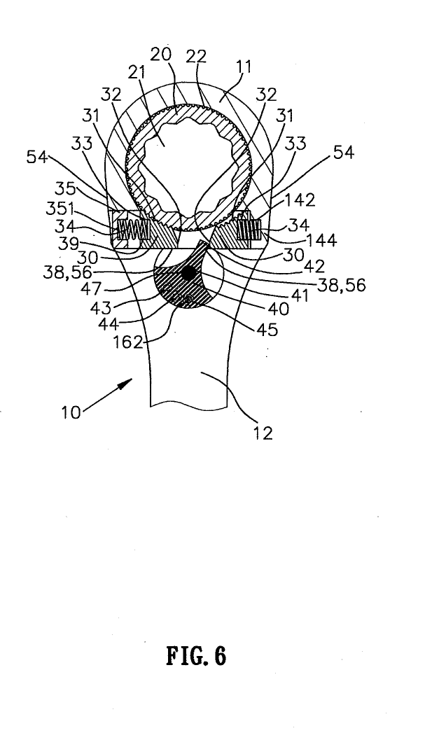

When the control member 40 is moved from the second operative position to the third operative position (FIG. 6), control section 42 of control member 40 presses against inner end 32 of second pawl 30, so that second pawl 30 is moved away from drive member 20. As a result, teeth 31 of second pawl 30 are disengaged from teeth 22 of drive member 20. Teeth 31 of first pawl 30 are still engaged with teeth 22 of drive member 20. In this state, drive member 20 can rotate in the counterclockwise direction to drive the fastener in the counterclockwise direction. Furthermore, drive member 20 can rotate freely in the clockwise direction without driving the fastener. As mentioned above, a portion of outer face 38 of first pawl 30 adjacent inner end 32 of first pawl 30 presses against a peripheral wall 56 delimiting second compartment 14 by a large area, so that the torque imparted to first pawl 30 can be transmitted to body 10. Accordingly, the ratchet wrench according to the preferred teachings of the present invention can withstand higher torque than conventional ones.

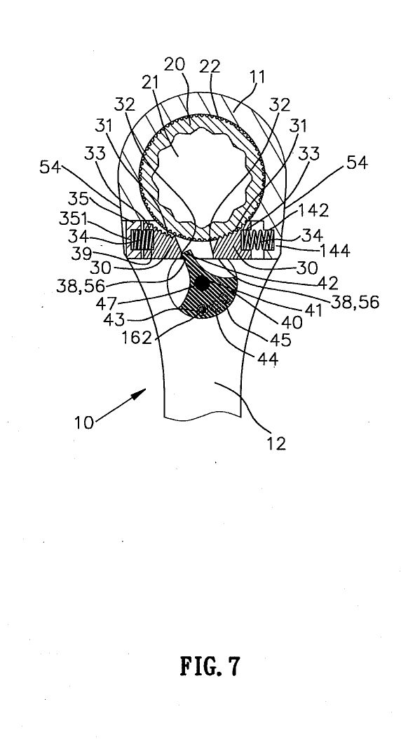

When the control member 40 is pivoted from the second operative position to the first operative position (FIG. 7), control section 42 of control member 40 presses against inner end 32 of first pawl 30, so that first pawl 30 is moved away from drive member 20. As a result, teeth 31 of first pawl 30 are disengaged from teeth 22 of drive member 20. Teeth 31 of second pawl 30 are still engaged with teeth 22 of drive member 20. Positioning member 162 is received in first positioning hole 43 of control member 40. In this state, drive member 20 can rotate in the clockwise direction to drive the fastener in the clockwise direction. Furthermore, drive member 20 can rotate freely in the counterclockwise direction without driving the fastener. As mentioned above, a portion of outer face 38 of second pawl 30 adjacent inner end 32 of second pawl 30 presses against a peripheral wall 56 delimiting second compartment 14 by a large area, so that the torque imparted to first pawl 30 can be transmitted to body 10. Accordingly, the ratchet wrench according to the preferred teachings of the present invention can withstand higher torque than conventional ones.

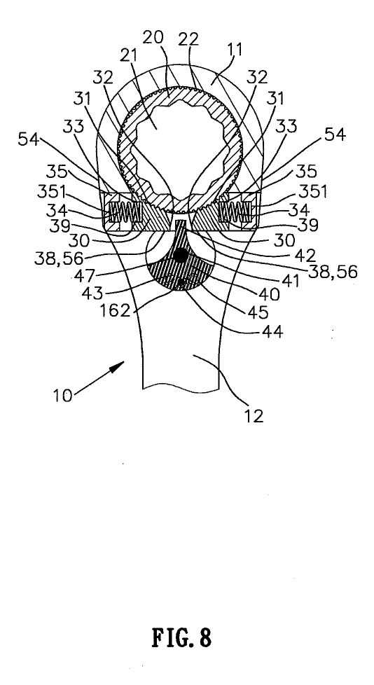

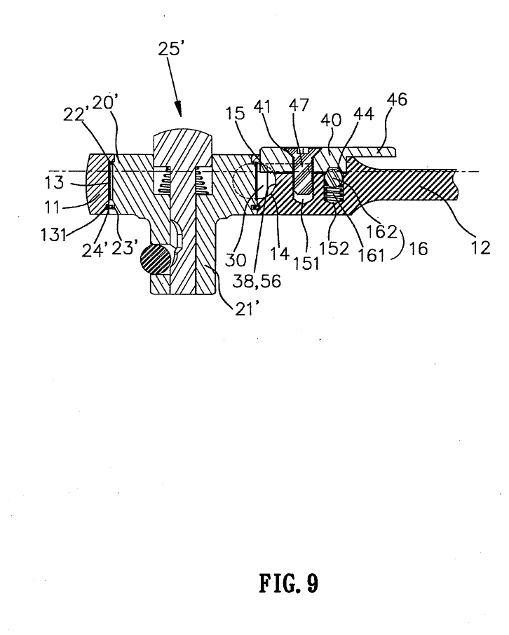

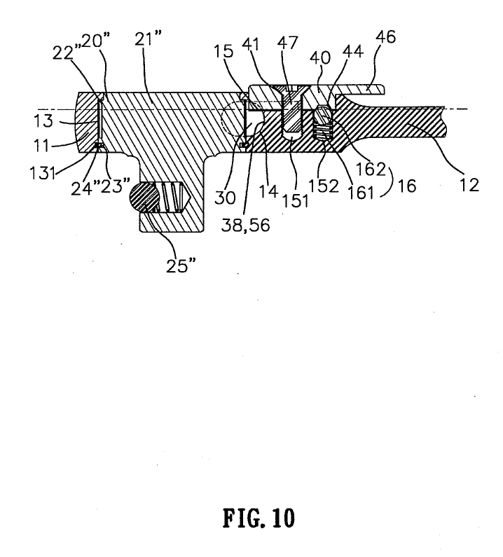

Now that the basic teachings of the present invention have been explained, many extensions and variations will be obvious to one having ordinary skill in the art. For example, thumb piece 46 can be omitted, and control member 40 can include a frictional outer periphery to allow easy manual operation to pivot control member 40 between the first, second, and third operative positions. Other arrangements allowing pivotal movement of control member 40 would be within the skill of the art. Drive member 20 can be of other forms. In a modified example shown in FIG. 9, drive member 20′ also includes a plurality of teeth 22′ and an annular groove 23′ in an outer periphery thereof. A retainer ring 24′ in the form of a C-clip is mounted in annular groove 23′ of drive member 20′ and annular groove 131 of body 10 to allow rotation of drive member 20′ in first compartment 13. Furthermore, drive member 20′ includes a drive section 21′ outside of driving portion 11 of body 10. Drive section 21 ′ is in the form of a drive column having square cross sections. Drive section 21′ includes a spring-biased coupler 25′ for releasable coupling with a socket. In another modified example shown in FIG. 10, drive member 20″ also includes a plurality of teeth 22″ and an annular groove 23″ in an outer periphery thereof. A retainer ring 24″ in the form of a C-clip is mounted in annular groove 23″ of drive member 20″ and annular groove 131 of body 10 to allow rotation of drive member 20″ in first compartment 13. Furthermore, drive member 20″ includes a drive section 21″ outside of driving portion 11 of body 10. Drive section 21″ is in the form of a drive column having square cross sections. Drive section 21″ includes a spring-biased quick-release coupler 25″ allowing releasable coupling with a socket. Other forms of drive member 20, 20′, 20″ would be within the skill of the art. Furthermore, second compartment 14 can include an opening 141 in each lateral side 54, and two plugs 351 are mounted in openings 141 and each include a receptacle 351 (FIG. 8). Each elastic element 34 has two ends received in receptacle 351 of one of plugs 35 and receptacle 39 of one of first and second pawls 30, providing the same operation as the above embodiments.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. A ratchet wrench comprising:
a body including a driving portion and a handle interconnected to the driving portion, with the driving portion including first and second sides spaced in a thickness direction, with the driving portion including a first compartment and a second compartment formed between the first and second sides and in communication with the first compartment, with the second compartment including at least one opening in communication with an outside, with a third compartment extending from the first side toward and spaced from the second side and in communication with the second compartment, with the third compartment including a bottom wall intermediate the first side and a center of the second compartment in the thickness direction;
at least one plug mounted in said at least one opening to seal said at least one opening;
a drive member rotatably received in the first compartment, with the drive member including a plurality of teeth in an outer periphery thereof;
first and second pawls slideably received in the second compartment, with each of the first and second pawls including inner and outer ends and an inner face interconnected between the inner and outer ends and facing the plurality of teeth of the drive member, with the inner face of each of the first and second pawls including a plurality of teeth releasably engaged with the plurality of teeth of the drive member;
a first elastic element mounted in the second compartment and biasing the outer end of the first pawl to engage the plurality of teeth of the first pawl with the plurality of teeth of the drive member;
a second elastic element mounted in the second compartment and biasing the outer end of the second pawl to engage the plurality of teeth of the second pawl with the plurality of teeth of the drive member; and
a control member pivotably mounted in the third compartment about a pivot axis, with the control member including a control section selectively pressing against the inner end of one of the first and second pawls to disengage the plurality of teeth of said one of the first and second pawls with the plurality of teeth of the drive member.

2. The ratchet wrench as claimed in claim 1, with the bottom wall of the third compartment including a fixing hole, with the control member including first and second faces spaced in the thickness direction, with the control member further including a through- hole extending from the first face through the second face, with a pivot extending through the through-hole of the control member and engaged in the fixing hole of the third compartment, and with the pivot defining the pivot axis and allowing rotational movement of the control member about the pivot axis.

3. The ratchet wrench as claimed in claim 2, with the fixing hole being a screw hole, and with the pivot including a screw threadedly engaged with the screw hole.

4. The ratchet wrench as claimed in claim 2, with the bottom wall of the third compartment further including a receiving hole, with the second face of the control member further including first, second, and third positioning holes corresponding to first, second, and third operative positions of the control member, with a positioning member and a third elastic element being received in the receiving hole, and with the third elastic element biasing the positioning member into one of the first, second, and third positioning holes to retain the control member in one of the first, second, and third operative positions.

5. The ratchet wrench as claimed in claim 4, with the control section including a rib formed on the second face, wherein:
when the control member is in the first operative position, the rib presses against the inner end of the first pawl to disengage the plurality of teeth of the first pawl from the plurality of teeth of the drive member, and the plurality of teeth of the second pawl are engaged with the plurality of teeth of the drive member, allowing the handle and the drive member to rotate in a first direction driving a fastener in the first direction, and allowing the the handle to rotate freely relative to the drive member in a second direction reverse to the first direction without driving the fastener,
when the control member is in the third operative position, the rib presses against the inner end of the second pawl to disengage the plurality of teeth of the second pawl from the plurality of teeth of the drive member, and the plurality of teeth of the first pawl are engaged with the plurality of teeth of the drive member, allowing the handle and the drive member to rotate in the second direction driving the fastener in the second direction, and allowing the the handle to rotate freely relative to the drive member in the first direction without driving the fastener, and
when the control member is in the second operative position, the rib is intermediate and spaced from the inner ends of the first and second pawls, the plurality of teeth of each of the first and second pawls are engaged with the plurality of teeth of the drive member, allowing the handle and the drive member to rotate in either of the first and second directions driving the fastener, and not allowing free rotation of the handle relative to the drive member in either of the first and second directions without driving the fastener.

6. The ratchet wrench as claimed in claim 5, with the driving portion of the body further including first and second lateral sides spaced in a width direction perpendicular to the thickness direction, with said at least one opening including an opening in the first lateral side, with said at least one plug including a plug mounted in the opening, with the outer end of the first pawl including a first receptacle, with the plug including a second receptacle, with the first elastic element having two ends received in the first and second receptacles and biasing the plurality of teeth of the first pawl to engage with the plurality of teeth of the drive member, with the outer end of the second pawl including a third receptacle, with the second compartment including a closed end wall opposite to the opening, with the closed end wall including a fourth receptacle, with the second elastic elements having two ends received in the third and fourth receptacles and biasing the plurality of teeth of the second pawl to engage with the plurality of teeth of the drive member.

7. The ratchet wrench as claimed in claim 5, with the driving portion of the body further including first and second lateral sides spaced in a width direction perpendicular to the thickness direction, with said at least one opening including first and second openings respectively in the first and second lateral sides, with said at least one plug including first and second plugs respectively mounted in the first and second openings, with the outer end of each of the first and second pawls including a first receptacle, with each of the first and second plugs including a second receptacle, with the first elastic element having two ends received in the first receptacle of the first pawl and the second receptacle of the first plug and biasing the plurality of teeth of the first pawl to engage with the plurality of teeth of the drive member with the second elastic element having two ends received in the first receptacle of the second pawl and the second receptacle of the second plug and biasing the plurality of teeth of the second pawl to engage with the plurality of teeth of the drive member.

8. The ratchet wrench as claimed in claim 5, with the second compartment intermediate the first and third compartments in a length direction perpendicular to the thickness direction, with the third compartment being spaced from the first compartment by a bridge that is a part of the first side of the driving portion, and with the bridge forming a sidewall delimiting the second compartment.

9. A ratchet wrench comprising:
a body including a driving portion and a handle interconnected to the driving portion, with the driving portion including a first compartment, a second compartment in communication with the first compartment, and a third compartment in communication with the second compartment, with the second compartment including at least one opening in communication with an outside;
at least one plug mounted in said at least one opening to seal said at least one opening;
a drive member rotatably received in the first compartment, with the drive member including a plurality of teeth in an outer periphery thereof;
first and second pawls slideably received in the second compartment, with each of the first and second pawls including inner and outer ends and an inner face interconnected between the inner and outer ends and facing the plurality of teeth of the drive member, with the inner face of each of the first and second pawls including a plurality of teeth releasably engaged with the plurality of teeth of the drive member,
a first elastic element mounted in the second compartment and biasing the outer end of the first pawl to engage the plurality of teeth of the first pawl with the plurality of teeth of the drive member;
a second elastic element mounted in the second compartment and biasing the outer end of the second pawl to engage the plurality of teeth of the second pawl with the plurality of teeth of the drive member; and
a control member pivotably mounted in the third compartment and pivotable between first, second, and third operative positions about a pivot axis, with the second operative position intermediate the first and third operative positions, with the control member including a control section,
wherein when the control member is in the first operative position, the plurality of teeth of the second pawl are engaged with the plurality of teeth of the drive member, the control section of the control member presses against the inner end of the first pawl to disengage the plurality of teeth of the first pawl from the plurality of teeth of the drive member, allowing the handle and the drive member to rotate in a first direction driving a fastener in the first direction, and allowing the handle to rotate freely relative to the drive member in a second direction reverse to the first direction without driving the fastener,
wherein when the control member is in the third operative position, the plurality of teeth of the first pawl are engaged with the plurality of teeth of the drive member, the control section of the control member presses against the inner end of the second pawl to disengage the plurality of teeth of the second pawl from the plurality of teeth of the drive member, allowing the handle and the drive member to rotate in the second direction driving the fastener in the second direction, and allowing the handle to rotate freely relative to the drive member in the first direction without driving the fastener, and
wherein when the control member is in the second operative position, the control section of the control member is intermediate and spaced from the inner ends of the first and second pawls, the plurality of teeth of each of the first and second pawls are engaged with the plurality of teeth of the drive member, allowing the handle and the drive member to rotate in either of the first and second directions driving the fastener, and not allowing free rotation of the handle relative to the drive member in either of the first and second directions without driving the fastener.

10. The ratchet wrench as claimed in claim 9, with the driving portion including first and second sides spaced in a thickness direction parallel to the pivot axis, with the third compartment extending from the first side toward and spaced from the second side, with the third compartment including a bottom wall having a fixing hole, with the control member including first and second faces spaced in the thickness direction, with the control member further including a through-hole extending from the first face though the second face, with a pivot extending through the through-hole of the control member and engaged in the fixing hole of the third compartment, with the pivot defining the pivot axis and allowing rotational movement of the control member about the pivot axis.

11. The ratchet wrench as claimed in claim 10, with the fixing hole being a screw hole, and with the pivot including a screw threadedly engaged with the screw hole.

12. The ratchet wrench as claimed in claim 10, with the bottom wall of the third compartment further including a receiving hole, with the second face of the control member further including first, second, and third positioning holes corresponding to the first, second, and third operative positions of the control member, with a positioning member and a third elastic element being received in the receiving hole, and with the third elastic element biasing the positioning member into one of the first, second, and third positioning holes to retain the control member in one of the first second, and third operative positions.

13. The ratchet wrench as claimed in claim 12, with the driving portion of the body further including first and second lateral sides spaced in a width direction perpendicular to The thickness direction, with said at least one opening including an opening in The first lateral side, with said at least one plug including a plug mounted in the opening, with the outer end of the first pawl including a first receptacle, with the plug including a second receptacle, with The first elastic element having two ends received in the first and second receptacles and biasing the plurality of teeth of the first pawl to engage with the plurality of teeth of the drive member, with the outer end of the second pawl including a third receptacle, with the second compartment including a closed end wall opposite to the opening, with the closed end wall including a fourth receptacle, with the second elastic elements having two ends received in the third and fourth receptacles and biasing the plurality of teeth of the second pawl to engage with the plurality of teeth of the drive member.

14. The ratchet wrench as claimed in claim 12, with the driving portion of the body further including first and second lateral sides spaced in a width direction perpendicular to the Thickness direction, with said at least one opening including first and second openings respectively in the first and second lateral sides, with said at least one plug including first and second plugs respectively mounted in the first and second openings, with the outer end of each of the first and second pawls including a first receptacle, with each of the first and second plugs including a second receptacle, with the first elastic element having two ends received in the first receptacle of the first pawl and the second receptacle of the first plug and biasing the plurality of teeth of the first pawl to engage with the plurality of teeth of the drive member, with the second elastic element having two ends received in the first receptacle of the second pawl and the second receptacle of the second plug and biasing the plurality of teeth of the second pawl to engage with the plurality of teeth of the drive member.

15. The ratchet wrench as claimed in claim 12, with the second compartment intermediate the first and third compartments in a length direction perpendicular to the thickness direction, with the third compartment being spaced from the first compartment by a bridge that is a part of the first side of the driving portion, and with the bridge forming a sidewall delimiting the second compartment.
